(19) United States
(12) Patent Application Publication
(10) Pub. No.: US 2013/0242090 A1
(43) Pub. Date: Sep. 19, 2013

(54) DISTANCE MEASUREMENT APPARATUS, DISTANCE MEASUREMENT METHOD, AND NON-TRANSITORY COMPUTER-READABLE STORAGE MEDIUM

(71) Applicant: Hiroshi Yoshikawa, Kawasaki-shi (JP)

(72) Inventor: Hiroshi Yoshikawa, Kawasaki-shi (JP)

(73) Assignee: CANON KABUSHIKI KAISHA, Tokyo (JP)

(21) Appl. No.: 13/989,125

(22) PCT Filed: Dec. 2, 2011
(86) PCT No.: PCT/JP2011/078500

§ 371 Date: May 23, 2013

(30) Foreign Application Priority Data
Dec. 15, 2010 (JP) 2010-279875

(51) Int. Cl. G01C 3/08

(52) U.S. Cl. CPC G01C 3/08
USPC 348/136

(57) ABSTRACT

A distance measurement apparatus comprising: modulation means for modulating a luminance value of measurement pattern light to be projected on a measurement object for each two-dimensional position of the pattern light within a predetermined luminance value range; projection means for projecting, on the measurement object, the pattern light modulated by the modulation means; image capturing means for capturing the measurement object on which the pattern light has been projected by the projection means; and distance calculation means for calculating a distance to the measurement object based on the captured image captured by the image capturing means.

### TECHNICAL FIELD

The present invention relates to a distance measurement apparatus and distance measurement method for measuring the distance to a measurement object in a non-contact manner, and a non-transitory computer-readable storage medium, and, more particularly, to a distance measurement apparatus and distance measurement method for measuring the distance to a measurement object by projecting pattern light, and a non-transitory computer-readable storage medium.

### BACKGROUND ART

Various methods have been proposed as a distance measurement method. They are roughly classified into a passive type for measuring distance using only an image capturing apparatus without using an illumination apparatus, and an active type for using an illumination apparatus and an image capturing apparatus in combination. In an active type method, an illumination apparatus projects pattern light on a measurement object and an image capturing apparatus captures an image. Even if there is little surface texture on the measurement object, it is possible to perform shape measurement using the pattern light. As an active type distance measurement method, various methods such as a space encoding method, a phase shift method, a grid pattern projection method, and a light-section method have been proposed. Since these methods are based on a triangulation method, it is possible to measure distance by obtaining the emitting direction of the pattern light from the projection apparatus.

In the space encoding method, pattern light including a plurality of line light beams is projected on a measurement object. Various encoding methods are used to identify a plurality of line light beams. As an encoding method, a gray code method is well known. The gray code method sequentially projects binary pattern light beams having different cycles on a measurement object, identifies line light beams by decoding, and obtains the emitting direction.

The phase shift method projects sinusoidal pattern light on a measurement object several times while shifting the phase of the pattern light. The method calculates the phase of the sinusoidal wave in each pixel using a plurality of captured images. The method performs phase connection as needed to uniquely identify the emitting direction of the pattern light.

The light-section method uses line light as pattern light. While scanning the line light on a measurement object, image capturing is repeated. It is possible to obtain the emitting direction of the pattern light from a scanning optical system or the like.

The grid pattern projection method projects, on a measurement object, a two-dimensional grid pattern embedded with encoded information such as an m-sequence or de Bruijn sequence. With this method, it is possible to obtain the emitting direction of the projected light by a small number of times of projection by decoding the encoded information of captured images.

Various methods have been proposed for the active type distance measurement apparatus, as described above. A luminance dynamic range, however, is limited. There are two main reasons for this. First, the captured image luminance of a measurement object on which pattern light has been projected depends on the reflectance of the measurement object. Second, the luminance dynamic range of an image capturing apparatus is limited. A detailed description will be given below.

For a measurement object having a high reflectance, the image luminance of pattern light is high. To the contrary, for a measurement object having a low reflectance, the image luminance of pattern light is low. Since the reflectance of a measurement object generally has angle characteristics, the image luminance also depends on the incident angle of pattern light and the capture angle of an image capturing apparatus. If the surface of a measurement object faces an image capturing apparatus and a projection apparatus, the image luminance of pattern light is relatively high. As the object surface turns away from the apparatuses, the image luminance of the pattern light becomes relatively low.

The luminance dynamic range of an image sensor used for the image capturing apparatus is limited. This is because the charge amount stored in a photodiode used for the image sensor is limited. If, therefore, the image luminance of the pattern light is too high, it becomes saturated. In such situation, it is impossible to correctly calculate the peak position of the pattern light, thereby decreasing the distance measurement accuracy. In the space encoding method, the pattern light may be misidentified, thereby causing a large error in distance measurement.

If the image luminance of the pattern light is too low, it reaches a level such that it cannot be detected as a signal. The image luminance may be buried in noise of the image sensor. In such situation, the distance measurement accuracy decreases. Furthermore, if it is impossible to detect the pattern light, a distance measurement operation itself becomes impossible.

As described above, in the active type distance measurement apparatus, the luminance dynamic range is limited. Therefore, the reflectance range and angle range of a measurement object within which a distance measurement operation is possible are also limited.

To solve the above problems, some conventional distance measurement apparatuses capture an image several times under different exposure conditions, and combine the obtained results (see Japanese Patent Laid-Open No. 2007-271530). In this method, however, the measurement time is prolonged in proportion to the number of image capturing operations.

To solve the above problems, some apparatuses change an amplification factor or transmittance for each line or each pixel of an image sensor (see Japanese Patent No. 4337281). In Japanese Patent No. 4337281, the luminance dynamic range is widened by changing the amplification factor depending on whether a line is an odd-numbered line or even-numbered line. In this method, however, it is necessary to use a special image sensor having different amplification factors for an odd-numbered line and even-numbered line.

In consideration of the above problems, the present invention provides a technique of widening the luminance dynamic range of an active type distance measurement apparatus without prolonging the measurement time or using any special image sensor.

### SUMMARY OF INVENTION

According to one aspect of the present invention, there is provided a distance measurement apparatus comprising: modulation means for modulating a luminance value of measurement pattern light to be projected on a measurement object for each two-dimensional position of the pattern light within a predetermined luminance value range; projection means for projecting, on the measurement object, the pattern light modulated by the modulation means; image capturing means for capturing the measurement object on which the pattern light has been projected by the projection means; and distance calculation means for calculating a distance to the measurement object based on the captured image captured by the image capturing means.

According to one aspect of the present invention, there is provided a distance measurement method comprising: a modulation step of modulating, within a predetermined luminance value range, a luminance value of measurement pattern light to be projected on a measurement object for each two-dimensional position where the pattern light is projected; a projection step of projecting, on the measurement object, the pattern light modulated in the modulation step; an image capturing step of capturing the measurement object on which the pattern light has been projected in the projection step; and a distance calculation step of calculating distance to the measurement object based on the captured image captured in the image capturing step.

Further features of the present invention will be apparent from the following description of exemplary embodiments with reference to the attached drawings.

### BRIEF DESCRIPTION OF DRAWINGS

FIG. 1 is a view showing the schematic configuration of a distance measurement apparatus according to the first embodiment;

FIG. 2 is a view showing projection patterns according to a conventional space encoding method;

FIG. 3 is a view showing the captured image luminance values of the projection patterns according to the conventional space encoding method;

FIG. 4 is a graph for explaining the relationship between the measurement accuracy and the captured image luminance value difference;

FIG. 5 is a view showing projection patterns according to the first embodiment;

FIG. 6 is a view showing captured image luminance values in a high luminance portion of a projection pattern;

FIG. 7 is a view showing captured image luminance values in an intermediate luminance portion of the projection pattern;

FIG. 8 is a view showing captured image luminance values in a low luminance portion of the projection pattern;

FIG. 9 is a flowchart illustrating a processing procedure according to the first embodiment;

FIG. 10 is a view showing projection patterns according to the second embodiment;

FIG. 11 is a view showing projection patterns according to the third embodiment;

FIG. 12 is a flowchart illustrating a processing procedure according to the third embodiment;

FIG. 13 is a view showing projection patterns according to the fourth embodiment;

FIG. 14 is a view showing projection patterns according to the fifth embodiment; and

FIG. 15 is a flowchart illustrating a processing procedure according to the fifth embodiment.

### DESCRIPTION OF EMBODIMENTS

An exemplary embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

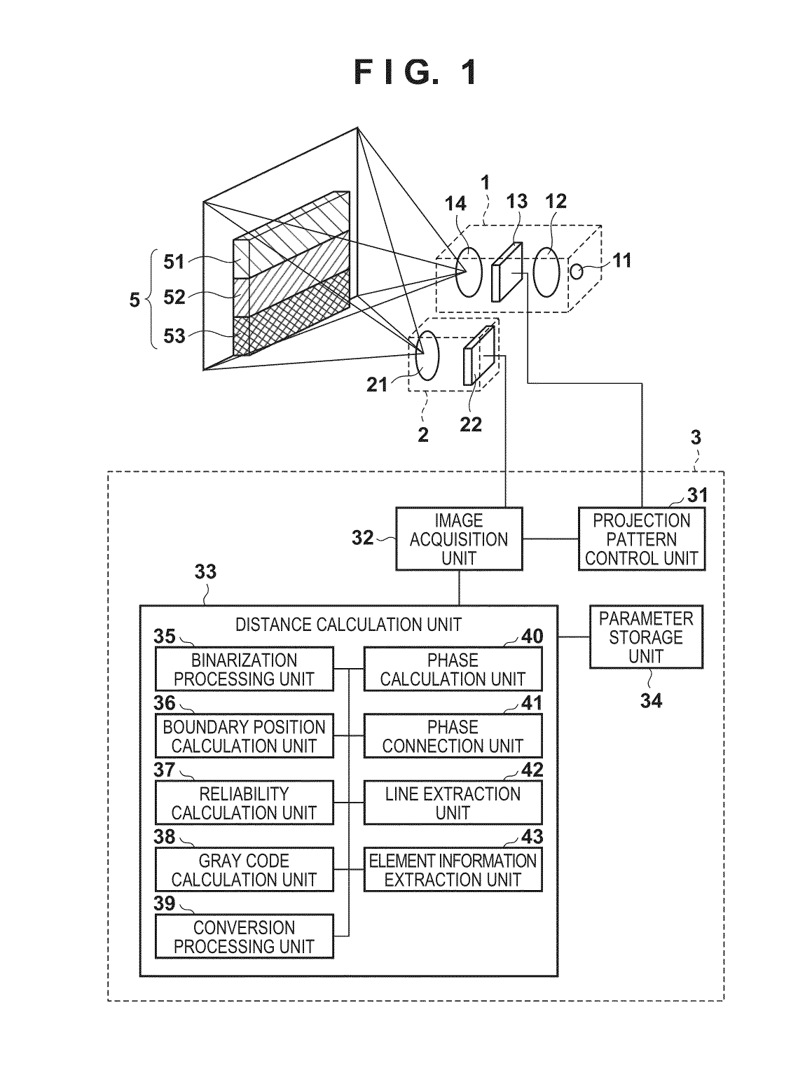

The schematic configuration of a distance measurement apparatus 100 according to the first embodiment will be explained with reference to FIG. 1. In the first embodiment, distance measurement using a space encoding method is performed. The distance measurement apparatus 100 includes a projection unit 1, an image capturing unit 2, and a control/computation processing unit 3. The projection unit 1 is configured to project pattern light on a measurement object 5. The image capturing unit 2 is configured to capture an image of the measurement object 5 on which the pattern light has been projected. The control/computation processing unit 3 is configured to control the projection unit 1 and image capturing unit 2, and to perform computation processing for the captured image data to measure the distance to the measurement object 5.

The projection unit 1 includes a light source 11, an illumination optical system 12, a display device 13, and a projection optical system 14. The light source 11 is one of various light emitting devices such as a halogen lamp and LED. The illumination optical system 12 has a function of guiding, to the display device 13, light emitted by the light source 11. At this time, the illumination optical system 12 guides light emitted by the light source 11 so that its illuminance becomes consistent on the display device 13. To do this, for example, an optical system such as a Koehler lamp or diffuser suitable for making the illuminance consistent is used. A transmissive LCD, a reflective LCOS or DMD, or the like is used as the display device 13. The display device 13 has a function of spatially controlling transmittance or reflectance in guiding light from the illumination optical system 12 to the projection optical system 14. The projection optical system 14 is configured to image the display device 13 at a specific position of the measurement object 5. Although the projection unit includes the display device 13 and the projection optical system 14 in this embodiment, a projection apparatus including spot light and a two-dimensional scanning optical system can be used. Alternatively, a projection apparatus including line light and one-dimensional scanning optical system can be used.

The image capturing unit 2 includes an imaging lens 21 and an image sensor 22. The imaging lens 21 is an optical system configured to image a specific position of the measurement object 5 on the image sensor 22. One of various photoelectric converters such as a CMOS or CCD sensor can be used as the image sensor 22.

The control/computation processing unit 3 includes a projection pattern control unit 31, an image acquisition unit 32, a distance calculation unit 33, a parameter storage unit 34, a binarization processing unit 35, a boundary position calculation unit 36, a reliability calculation unit 37, a gray code calculation unit 38, and a conversion processing unit 39. Note that each of a phase calculation unit 40, a phase connection unit 41, a line extraction unit 42, and an element information extraction unit 43 is not indispensable in the first embodiment, and is used in other embodiments (to be described later) in which different distance measurement methods are used. The function of each unit will be described later.

The hardware of the control/computation processing unit 3 includes a general-purpose computer comprising a CPU, a storage device such as a memory and hard disk, and various input/output interfaces. The software of the control/computation processing unit 3 includes a distance measurement program for causing a computer to execute a distance measurement method according to the present invention.

Each of the projection pattern control unit 31, image acquisition unit 32, distance calculation unit 33, parameter storage unit 34, binarization processing unit 35, boundary position calculation unit 36, reliability calculation unit 37, gray code calculation unit 38, and conversion processing unit 39 is implemented when the CPU executes the above-mentioned distance measurement program.

The projection pattern control unit 31 is configured to generate a projection pattern (to be described later), and store it in the storage device in advance. The unit 31 is also configured to read out the data of the stored projection pattern as needed, and transmit the projection pattern data to the projection unit 1 via, for example, a general-purpose display interface such as a DVI interface. Furthermore, the unit 31 has a function of controlling the operation of the projection unit 1 via a general-purpose communication interface such as an RS232C or IEEE488 interface. Note that the projection pattern control unit 31 is configured to display a projection pattern on the display device 13 of the projection unit 1 based on the projection pattern data.

The image acquisition unit 32 is configured to accept a digital image signal which has been sampled and quantized in the image capturing unit 2. The unit 32 has a function of acquiring image data represented by the luminance value of each pixel from the accepted image signal, and storing it in the memory. Note that the image acquisition unit 32 has a function of controlling the operation (such as an image capturing timing) of the image capturing unit 2 via a general purpose communication interface such as an RS232C or IEEE488 interface.

The image acquisition unit 32 and the projection pattern control unit 31 cooperatively operate. Upon completion of pattern display on the display device 13, the projection pattern control unit 31 sends a signal to the image acquisition unit 32. Upon receiving the signal from the projection pattern control unit 31, the image acquisition unit 32 operates the image capturing unit 2 to capture an image. Upon completion of the image capturing, the image acquisition unit 32 sends a signal to the projection pattern control unit 31. Upon receiving the signal from the image acquisition unit 32, the projection pattern control unit 31 switches the projection pattern displayed on the display device 13 to a next projection pattern. By sequentially repeating the processing, images of all projection patterns are captured. The distance calculation unit 33 uses the captured images of the projection patterns and parameters stored in the parameter storage unit 34 to calculate the distance to the measurement object.

The parameter storage unit 34 is configured to store parameters necessary for calculating three-dimensional distance. The parameters include the device parameters, intrinsic parameters, and extrinsic parameters of the projection unit 1 and image capturing unit 2.

The device parameters include the number of pixels of the display device, and the number of pixels of the image sensor. The intrinsic parameters of the projection unit 1 and image capturing unit 2 include a focal length, an image center, and an image distortion coefficient due to distortion. The extrinsic parameters of the projection unit 1 and image capturing unit 2 include a translation matrix and rotation matrix which represent the relative positional relationship between the projection unit 1 and the image capturing unit 2. In the space encoding method, the binarization processing unit 35 compares the luminance value of a pixel of a positive pattern captured image and that of a pixel of a negative pattern captured image. If the luminance value of the positive pattern captured image is equal to or larger than that of the negative pattern captured image, the unit 35 sets a binary value to 1; otherwise, the unit 35 sets a binary value to 0, thereby implementing binarization.

The boundary position calculation unit 36 is configured to calculate, as a boundary position, a position where the binary value changes from 0 to 1 or from 1 to 0.

The reliability calculation unit 37 is configured to calculate various reliabilities. The calculation of the reliabilities will be explained in detail later. The gray code calculation unit 38 is configured to combine the binary values of the respective bits calculated by the binarization processing unit 35, and calculate a gray code. The conversion processing unit 39 is configured to convert the gray code calculated by the gray code calculation unit 38 into a display device coordinate value of the projection unit 1.

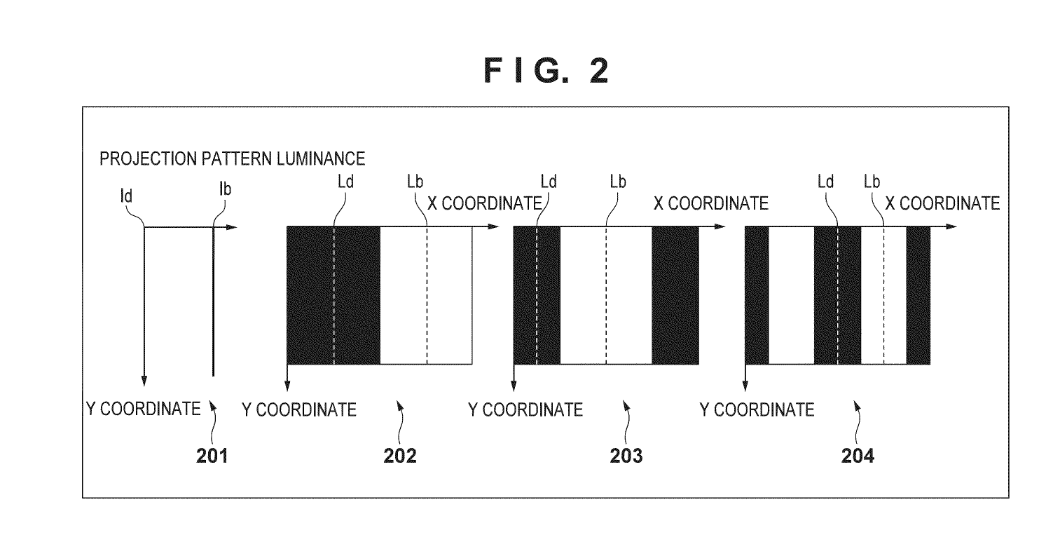

Assume that the measurement object 5 has a high reflectance region 51 having a high reflectance, an intermediate reflectance region 52 having an intermediate reflectance, and a low reflectance region 53 having a low reflectance. The basic configuration of the distance measurement apparatus according to the first embodiment has been described. The principle of a space encoding method will be explained next. FIG. 2 shows projection pattern examples used by a conventional space encoding method. Reference numeral 201 denotes a projection pattern luminance; and 202 to 204, gray code pattern light. More specifically, reference numeral 202 denotes a 1-bit gray code pattern; 203, a 2-bit gray code pattern; and 204, a 3-bit gray code pattern. A 4-bit gray code pattern and subsequent gray code patterns are omitted.

In the graph 201, the abscissa represents the projection pattern luminance and the ordinate represents the y coordinate of the projection pattern. A luminance lb in the graph 201 represents the projection pattern luminance of a vertical line Lb in a bright region in the gray code pattern 202, 203, or 204. A luminance ld in the graph 201 represents the luminance of a vertical line Ld in a dark region in the gray code pattern 202, 203, or 204. In a projection pattern used by the conventional space encoding method, the luminances lb and ld are constant in the y coordinate direction.

In the space encoding method, image capturing is performed while sequentially projecting the gray code patterns 202 to 204. Then, a binary value is calculated in each bit. More specifically, if the image luminance of a captured image in each bit is equal to or larger than a threshold, the binary value of the region is set to 1; otherwise, the binary value of the region is set to 0. The binary values of the bits are sequentially arranged, which results in a gray code for the region. The gray code is converted into a spatial code, thereby measuring distance.

As a method of determining a threshold, a mean value method and complementary pattern projection method are well known. In the mean value method, a captured image in which the whole area is bright and a captured image in which the whole area is dark are acquired in advance. The mean value of two image luminances is used as a threshold. On the other hand, in the complementary pattern projection method, a negative pattern (second gray code pattern) obtained by reversing bright positions and dark positions of the respective bits of the gray code pattern (positive pattern) is projected, thereby capturing an image. The image luminance value of the negative pattern is used as a threshold.

In general, for the space encoding method, there is ambiguity in position corresponding to the width of the least significant bit. It is, however, possible to reduce the ambiguity with respect to the bit width by detecting, on the captured image, a boundary position where the binary value changes from 0 to 1 or from 1 to 0, thereby improving the distance measurement accuracy. The present invention is applicable to both the mean value method and complementary pattern projection method. A case in which the complementary pattern projection is adopted will be exemplified below.

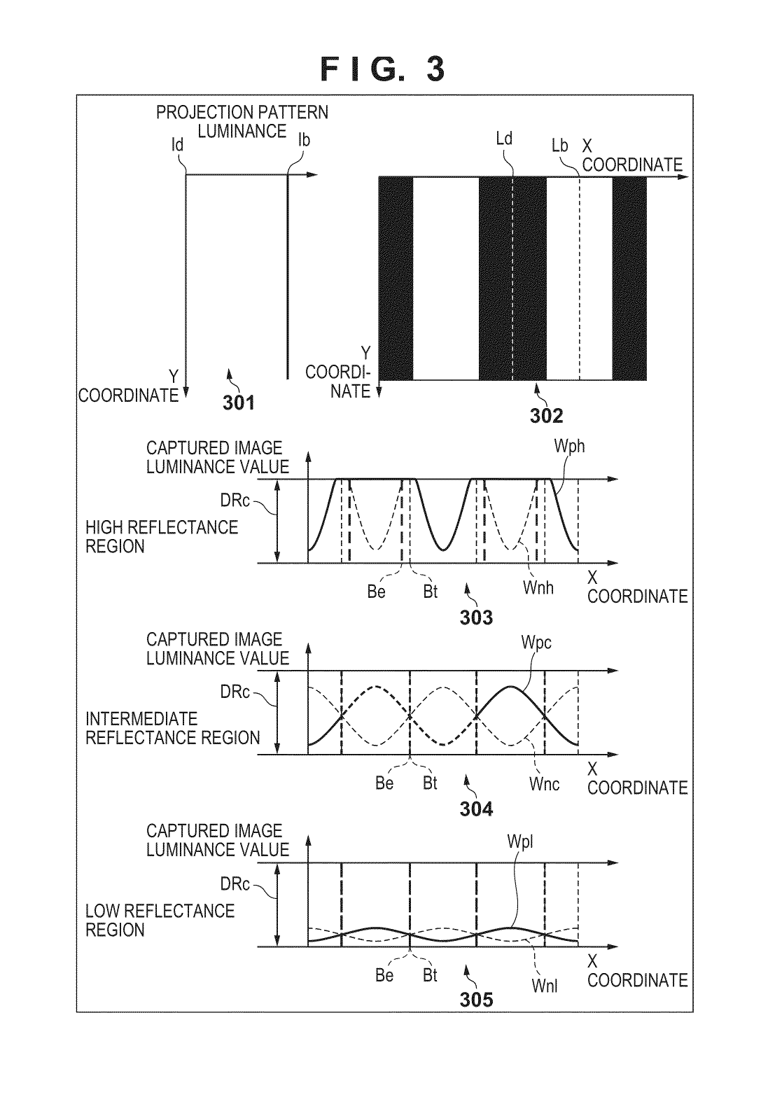

Problems associated with the conventional space encoding method will be described with reference to FIG. 3. Reference numerals 303 to 305 denote the schematic representations of captured image luminance values obtained when a projection pattern represented by graphs 301 and 302 is projected on the measurement object 5. The graphs 301 and 302 correspond to the graphs 201 and 204, respectively. A physical quantity of light incident on the surface of the image sensor is generally an illuminance. The illuminance on the surface of the image sensor is photoelectrically converted in the photodiodes of the pixels of the image sensor, and then undergoes A/D conversion and quantization. The quantized value corresponds to the captured image luminance value 303, 304, or 305.

As described above, the measurement object 5 has the high reflectance region 51 having a high reflectance, the intermediate reflectance region 52 having an intermediate reflectance, and the low reflectance region 53 having a low reflectance. In the graphs 303 to 305, the ordinate represents the image luminance of a captured image and the abscissa represents the x coordinate. The graph 303 shows the image luminance of the high reflectance region. The graph 304 shows the image luminance of the intermediate reflectance region. The graph 305 shows the image luminance of the low reflectance region. A luminance received by the image sensor is generally in proportion to a projection pattern luminance, the reflectance of a capturing object, and an exposure time. Note that a luminance receivable as a valid signal by the image sensor is limited by the luminance dynamic range of the image sensor. Let lcmx be a maximum luminance receivable by the image sensor and lcmin be a minimum luminance. Then, a luminance dynamic range DRc of the image sensor is given by

DRc=20 log (lcmax/lcmin) (1)

The unit of the luminance dynamic range DRc calculated according to equation (1) is dB (decibel). The luminance dynamic range for a general image sensor is about 60 dB. This means that it is possible to detect a luminance as a signal only up to a maximum luminance-to-minimum luminance ratio of 1,000. In other words, it is impossible to capture a scene in which the reflectance ratio of a capturing object is 1,000 or more.

In the graph 303, the high reflectance region has a high reflectance, and therefore, the captured image luminance value is saturated. Let Wph be a positive pattern image luminance waveform and Wnh be a negative pattern image luminance waveform. When the image luminance becomes saturated, a shift occurs between a detected pattern boundary position Be and a true pattern boundary position Bt. This shift causes a measurement error. Furthermore, when the shift amount becomes larger than the minimum bit width of the pattern, a code value error occurs, thereby causing a large measurement error.

In the graph 304, the captured image luminance value of the intermediate reflectance region is appropriate. Let Wpc be a positive pattern image luminance waveform and Wnc be a negative pattern image luminance waveform. Since the image luminance is never saturated, no large shift occurs between the detected pattern boundary position Be and the true pattern boundary position Bt. Furthermore, since image capturing is performed with the contrast of the projection pattern set high, the boundary position estimation accuracy is high. In general, the boundary position estimation accuracy depends on a difference between image luminance values in the neighborhood of a boundary position.

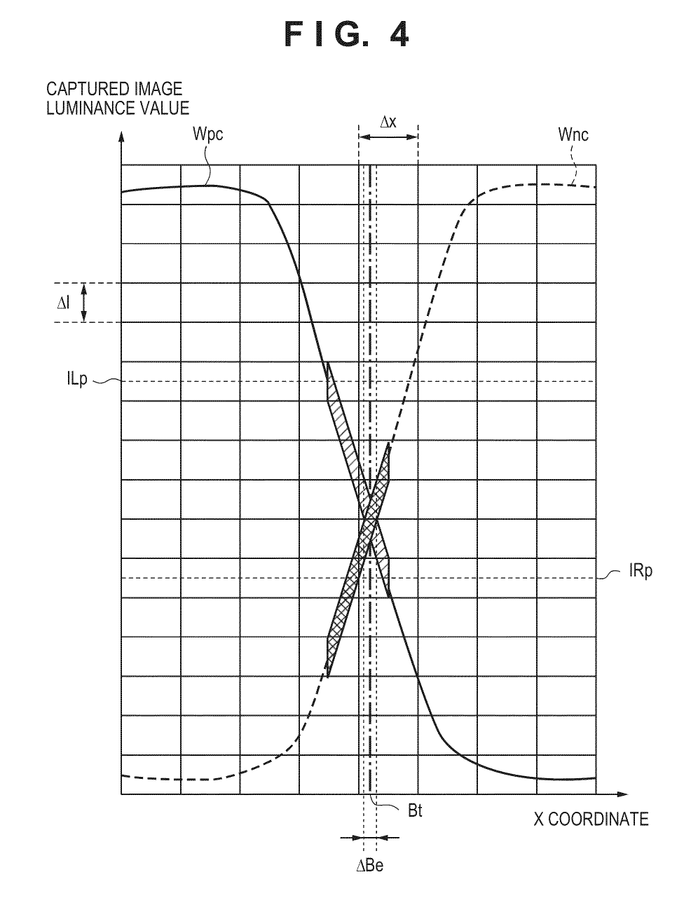

The relationship between the estimation accuracy and the image luminance value difference will be described with reference to FIG. 4. Referring to FIG. 4, the abscissa represents the x coordinate and the ordinate represents the captured image luminance value. To explicitly indicate that a digital image has been captured, quantization in the spatial direction and quantization in the luminance direction by pixels are represented by a grid. Let Δx be a quantization error value in the spatial direction and Δl be a quantization pixel value in the luminance direction. The positive pattern waveform Wpc and the negative pattern waveform Wnc are represented as analog waveforms. In the positive pattern waveform Wpc, let lLp be an image luminance value adjacent on the left side of the boundary position and lRp be an image luminance value on the right side. Then, the boundary position is estimated based on ambiguity ΔBe obtained by

ΔBe=Δl·Δx/abs(lLp−lRp) (2)

Note that abs( ) indicates a function of outputting an absolute value bracketed by ( ). Equation (2) is used when it is possible to effectively ignore image noise. If noise exists, ambiguity ΔN is added in the luminance direction. The ambiguity ΔBe in boundary position increases according to

ΔBe=(Δl+ΔN)·Δx/abs(lLp−lRp) (3)

According to equations (2) and (3), as the difference between the image luminance values of two neighboring pixels of the boundary position is larger, the ambiguity ΔBe for boundary position estimation is smaller and the measurement accuracy is higher.

In the graph 305, the captured image luminance value of the low reflectance region is low. Let Wpl be a positive pattern image luminance waveform and Wnl be a negative pattern image luminance waveform. Since it is possible to acquire only the pattern light with a low contrast waveform, the difference between two neighboring pixels of the boundary position is small. That is, the ambiguity ΔBe in boundary position becomes large, and the accuracy becomes low. If the reflectance of the measurement object 5 is lower, it becomes impossible to receive the pattern light as a signal, thereby disabling distance measurement.

As described above, in the conventional space encoding method pattern, the limitation of the luminance dynamic range of the image sensor limits a reflectance range within which measurement with high accuracy is possible.

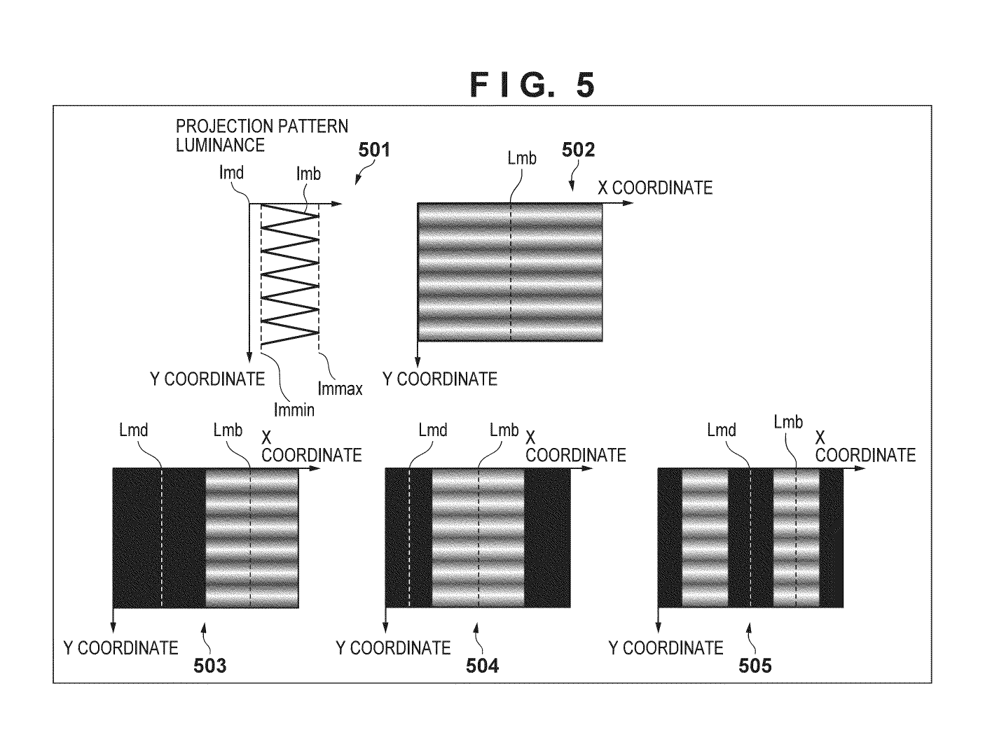

The present invention will be described next. FIG. 5 shows projection pattern examples used in the first embodiment. In the first embodiment, the projection pattern luminance of a basic gray code pattern is changed (luminance-modulated) in a direction approximately perpendicular to a base line direction which connects the projection unit 1 with the image capturing unit 2. That is, the luminance value of the pattern light projected on the measurement object is modulated within a predetermined luminance value range for each two-dimensional position where the pattern light is projected. This can widen the range of the reflectance of the measurement object 5, which is receivable as pattern light by the image sensor. Since the contrast of the pattern light on the image sensor can also be adjusted, it is possible to improve the measurement accuracy.

The patterns shown in FIG. 5 are obtained by one-dimensionally luminance-modulating a projection pattern used in the conventional space encoding in FIG. 2 within a predetermined luminance value range in the y coordinate direction. Graphs 501 and 502 show a luminance modulation waveform for a measurement pattern. In the graph 501, the abscissa represents the projection pattern luminance and the ordinate represents the y coordinate of the projection pattern. In the graph 502, the abscissa represents the x coordinate and the ordinate represents the y coordinate. Reference numerals 503 to 505 denote gray code patterns undergone luminance modulation with the luminance modulation waveform shown in the graphs 501 and 502. More specifically, reference numeral 503 denotes a 1-bit gray code pattern; 504, a 2-bit gray code pattern; and 505, a 3-bit gray code pattern. A 4-bit gray code pattern and subsequent gray code patterns are omitted.

The y coordinate direction of the display device corresponds to a direction approximately perpendicular to the base line direction which connects the projection unit 1 with the image capturing unit 2. When the luminance modulation direction is perpendicular to an epipolar line direction which is determined based on a spatial positional relationship among the projection unit 1, the image capturing unit 2, and the measurement object 5, maximum performance can be obtained. Note that even when the luminance modulation direction is not perpendicular to the epipolar line direction, it is possible to sufficiently obtain the effects of the present invention.

FIG. 5 shows the triangular luminance modulation waveform as a predetermined luminance value cycle but a luminance modulation waveform is not limited to this. A periodic luminance modulation waveform other than a triangular waveform, for example, a stepped waveform, sinusoidal waveform, or sawtooth waveform may be applied. Furthermore, a periodic luminance modulation waveform need not be used, and a random luminance modulation waveform may be used.

For a periodic luminance modulation waveform, a modulation cycle is appropriately selected depending on the size of the measurement object 5. Let S be the length of a short side of the measurement object 5, Z be capturing distance, and fp be the focal length of the projection optical system. Then, the width w of one cycle on the display device is set so as to satisfy

w<S·fp/Z (4)

By satisfying equation (4), it becomes possible to measure at least one point of the measurement object 5. It is possible to adjust the effect of luminance dynamic range widening using the amplitude of luminance modulation. Let lmmax be a maximum luminance of luminance modulation and lmmin be a minimum luminance. Then, a widened width DRm of the dynamic range is given by

DRm=20 log (lmmax/lmmin) (5)

Using the above-described luminance dynamic range DRc of the image sensor, a total dynamic range DR according to the present invention is given by

DR=DRc+DRm (6)

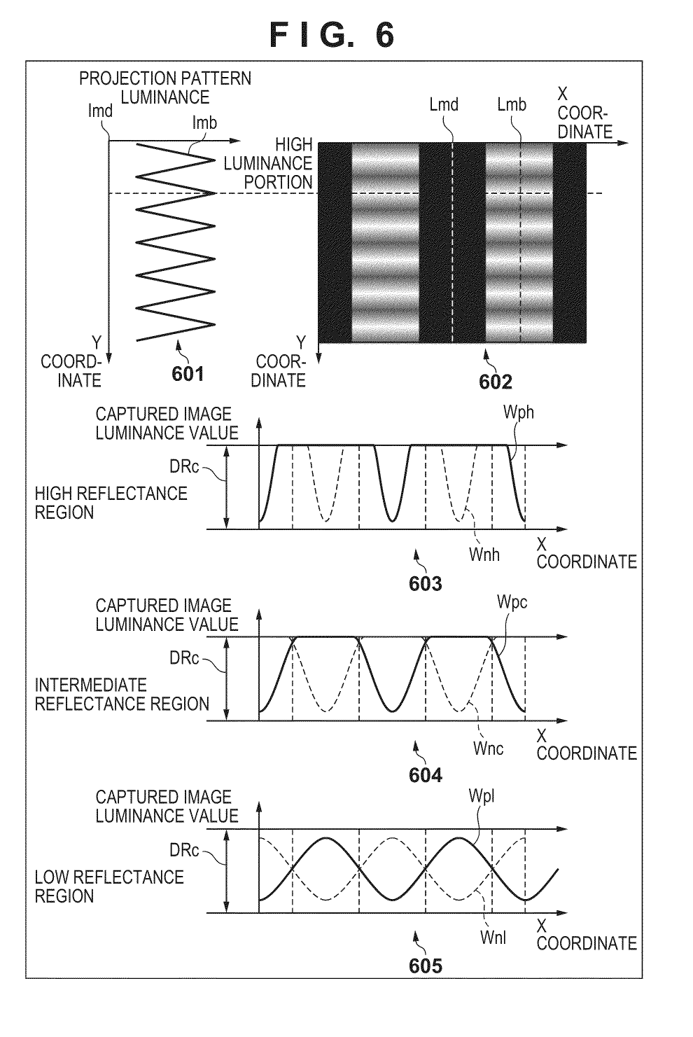

The principle of widening the dynamic range by the projection patterns shown in FIG. 5 will be schematically described with reference to FIGS. 6, 7, and 8.

Referring to FIGS. 6, 7, and 8, graphs 601, 701, and 801 respectively correspond to the graph 501. Furthermore, graphs 602, 702, and 802 respectively correspond to the graph 505. Reference numeral 603, 703, or 803 denotes the captured image luminance value of a high reflectance region; 604, 704, or 804, the captured image luminance value of an intermediate reflectance region; and 605, 705, or 805, the captured image luminance value of a low reflectance region. Furthermore, FIGS. 6, 7, and 8 correspond to the captured image luminance values of a high luminance portion, an intermediate luminance portion, and a low luminance portion of a projection pattern luminance, respectively.

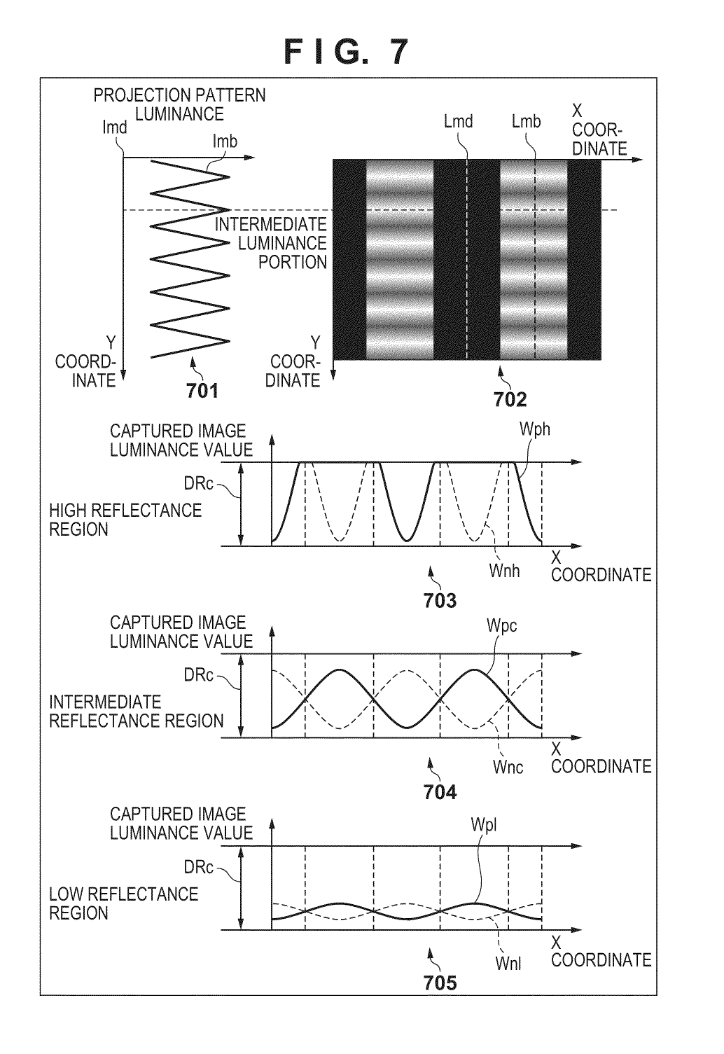

As shown in FIG. 6, in the high luminance portion of the projection pattern luminance, the positive pattern waveform Wph and the negative pattern waveform Wnh are saturated in the high reflectance region shown in the graph 603. Also, in the intermediate reflectance region shown in the graph 604, the positive pattern waveform Wpc and the negative pattern waveform Wnc are saturated. A measurement error is large both in the high reflectance region and the intermediate reflectance region. In the low reflectance region shown in the graph 605, the positive pattern waveform Wpl and the negative pattern waveform Wnl are high contrast waveforms, thereby enabling measurement with high accuracy. As shown in FIG. 7, in the intermediate luminance portion of the projection pattern luminance, the positive pattern waveform Wph and the negative pattern waveform Wnh are saturated in the high reflectance region shown in the graph 703. Therefore, a measurement error is large. In the intermediate reflectance region shown in the graph 704, the positive pattern waveform Wpc and the negative pattern waveform Wnc are high contrast waveforms, thereby enabling measurement with high accuracy. In the low reflectance region shown in the graph 705, the positive pattern waveform Wpl and the negative pattern waveform Wnl are low contrast waveforms, and therefore, the measurement accuracy is low.

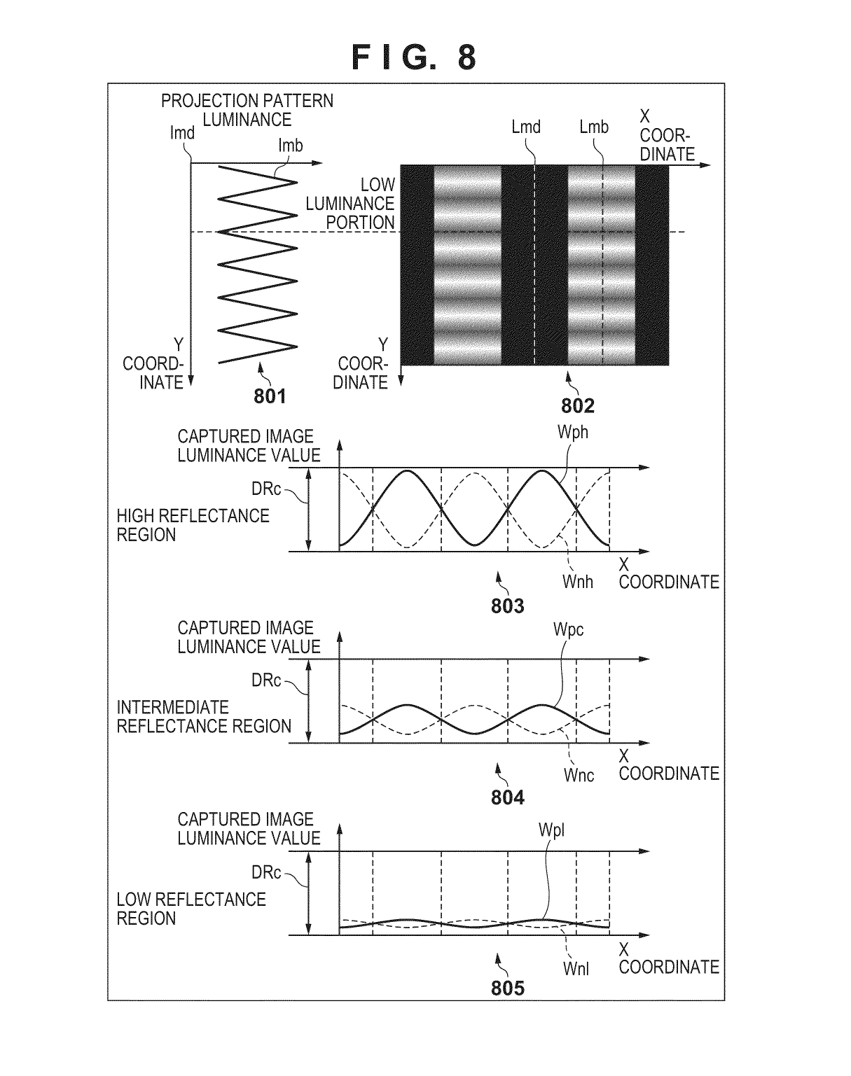

As shown in FIG. 8, in the low luminance portion of the projection pattern luminance, the positive pattern waveform Wph and the negative pattern waveform Wnh are high contrast waveforms in the high reflectance region shown in the graph 803, thereby enabling measurement with high accuracy. In the intermediate reflectance region shown in the graph 804, the positive pattern waveform Wpc and the negative pattern waveform Wnc are low contrast waveforms, and therefore, the measurement accuracy is low. In the low reflectance region shown in the graph 805, the positive pattern waveform Wpl and the negative pattern waveform Wnl are lower contrast waveforms, and therefore, the measurement accuracy further decreases.

Table 1 summarizes the above description. In the conventional space encoding method, a reflectance at which measurement with high accuracy is possible is limited to the intermediate reflectance region. To the contrary, it is found in the present invention that by changing the luminance of a basic measurement pattern depending on a position, it is possible to perform measurement with high accuracy in all the reflectance regions, that is, all of the low reflectance region, the intermediate reflectance region, and the high reflectance region.

TABLE 1

| | | present invention | | |
|---|---|---|---|---|
| | | high | intermediate | low |
| | conventional | luminance | luminance | luminance |
| | method | portion | portion | portion |
| high | large error | large error | large error | high |
| reflectance | (saturated) | (saturated) | (saturated) | accuracy |
| region | | | | |
| intermediate | high | large error | high | low |
| reflectance | accuracy | (saturated) | accuracy | accuracy |
| region | | | | (low |
| | | | | contrast) |
| low | low accuracy | high | low accuracy | low |
| reflectance | (low | accuracy | (low | accuracy |
| region | contrast) | | contrast) | (low |
| | | | | contrast) |

The principle of widening the luminance dynamic range of distance measurement according to the present invention has been described.

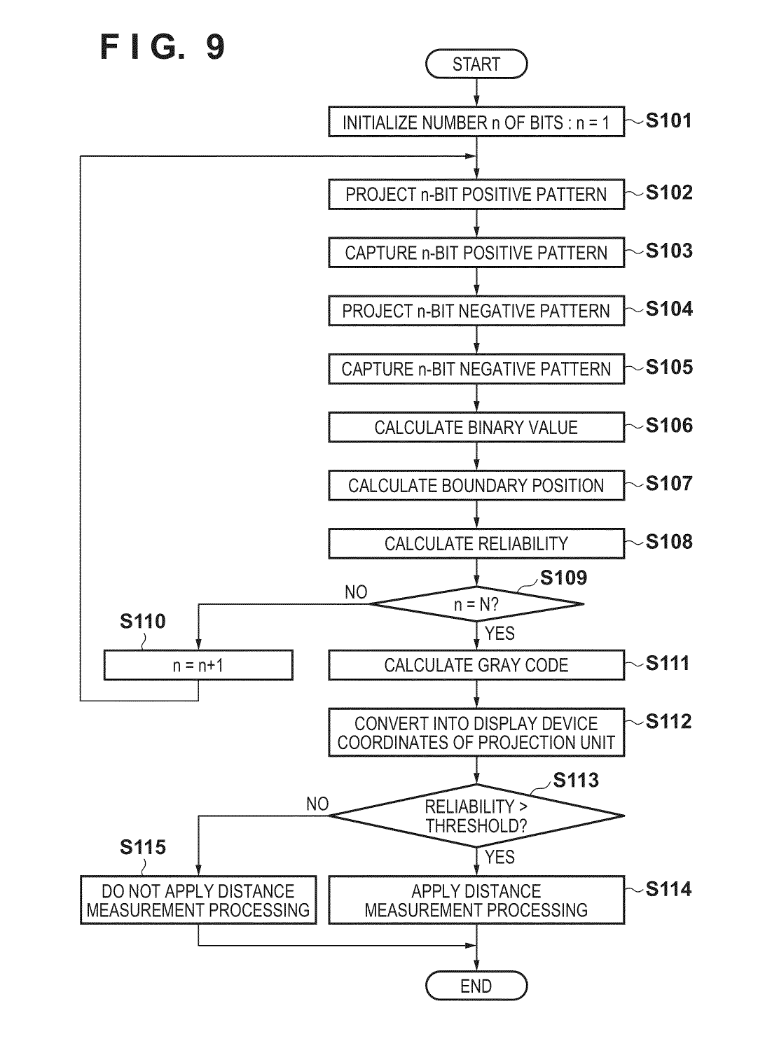

A processing procedure according to the first embodiment will be explained with reference to a flowchart of FIG. 9. Assume that in the first embodiment, an N-bit gray code pattern is projected.

In step S101, the projection pattern control unit 31 initializes a number n of bits to 1. In step S102, the projection unit 1 projects an n-bit positive pattern.

In step S103, the image capturing unit 2 captures an image of the measurement object 5 on which the n-bit positive pattern has been projected. In step S104, the projection unit 1 projects an n-bit negative pattern. In step S105, the image capturing unit 2 captures an image of the measurement object 5 on which the n-bit negative pattern has been projected.

In step S106, the binarization processing unit 35 performs binarization processing to calculate a binary value. More specifically, the unit 35 compares the luminance value of a pixel of the positive pattern captured image with that of a pixel of the negative pattern captured image. If the luminance value of the positive pattern captured image is equal to or larger than that of the negative pattern captured image, the unit 35 sets the binary value to 1; otherwise, the unit 35 sets the binary value to 0.

In step S107, the boundary position calculation unit 36 calculates a boundary position. The unit 36 calculates, as a boundary position, a position where the binary value changes from 0 to 1 or from 1 to 0. If it is desired to obtain the boundary position with sub-pixel accuracy, it is possible to obtain the boundary position by performing linear fitting or higher-order function fitting based on the captured image luminance values in the neighborhood of the boundary position.

In step S108, the reliability calculation unit 37 calculates a reliability at each boundary position. It is possible to calculate the reliability based on, for example, the ambiguity ΔBe in boundary position calculated according to equation (2) or (3). As the ambiguity ΔBe in boundary position is larger, the reliability is lower. Therefore, the reciprocal of the ambiguity can be used to calculate the reliability according to

Cf=1/ΔBe (7)

The reliability may be set to 0 for a pixel where there is no boundary position.

In step S109, the projection pattern control unit 31 determines whether the number n of bits reaches N. If it is determined that n does not reach N (NO in step S109), the process advances to step S110 to add 1 to n; otherwise (YES in step S109), the process advances to step S111.

In step S111, the gray code calculation unit 38 combines the binary values calculated in step S106 in the respective bits, and calculates a gray code. In step S112, the conversion processing unit 39 converts the gray code into a display device coordinate value of the projection unit 1. Once the gray code is converted into a display device coordinate value of the projection unit 1, the emitting direction from the projection unit 1 is obtained, thereby enabling to perform distance measurement.

In step S113, the reliability calculation unit 37 determines for each pixel of the captured image whether a corresponding reliability is larger than a threshold. If it is determined that the reliability is larger than the threshold (YES in step S113), the process advances to step S114; otherwise (NO in step S113), the process advances to step S115.

In step S114, the distance calculation unit 33 applies distance measurement processing using a triangulation method. Then, the process ends. In step S115, the distance calculation unit 33 ends the process without applying distance measurement processing.

It is possible to determine the threshold for the reliability by, for example, converting measurement accuracy ensured by the distance measurement apparatus into a reliability. The processing procedure according to the first embodiment has been described.

For a region with a reliability smaller than the threshold where no distance measurement has been performed, it is possible to perform interpolation processing for distance measurement results of regions with a high reliability. The first embodiment of the present invention has been described.

According to the first embodiment, it is possible to widen the luminance dynamic range of an active type distance measurement apparatus without prolonging the measurement time or using any special image sensor.

### Second Embodiment

The schematic configuration of a distance measurement apparatus according to the second embodiment of the present invention is the same as that shown in FIG. 1 in the first embodiment.

In the first embodiment, the luminance of a projection pattern is modulated only in the y coordinate direction. Therefore, the measurable reflectance range is one-dimensionally distributed. In the second embodiment, by two-dimensionally modulating a pattern in the x coordinate direction and the y coordinate direction, a measurable reflectance range is two-dimensionally distributed.

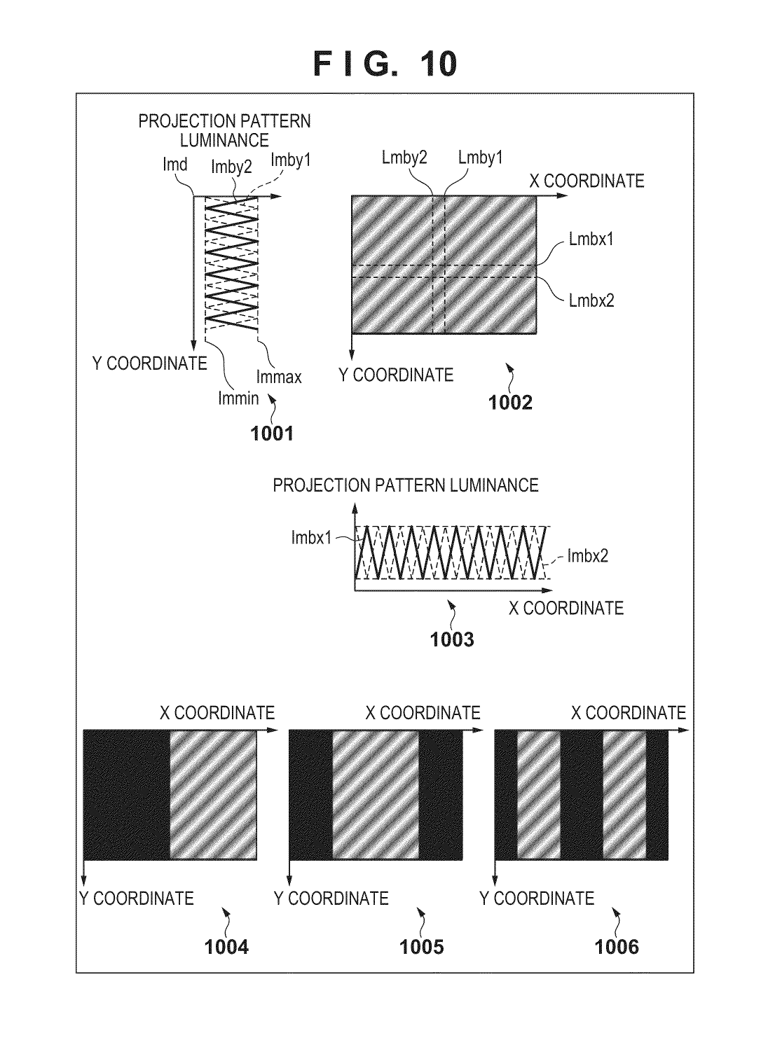

FIG. 10 shows projection patterns used in the second embodiment. In the second embodiment, as shown in graphs 1001 to 1003, a measurement pattern is modulated with luminance modulation waveforms two-dimensionally luminance-modulated in the x coordinate direction and the y coordinate direction. This enables to two-dimensionally distribute a measurable reflectance range. In the graph 1001, the abscissa represents the projection pattern luminance and the ordinate represents the y coordinate of the projection pattern. In a projection pattern 1002, the abscissa represents the x coordinate and the ordinate represents the y coordinate. In the graph 1003, the abscissa represents the x coordinate and the ordinate represents the projection pattern luminance. Reference numerals 1004, 1005, and 1006 denote 1-, 2-, and 3-bit gray code patterns used in the second embodiment, respectively. A 4-bit gray code pattern and subsequent gray code patterns are omitted.

The projection pattern luminances of vertical lines Lmby1 and Lmby2 in the graph 1002 correspond to waveforms lmby1 and Lmby2 in the graph 1001, respectively. The projection pattern luminances of horizontal lines Lmbx1 and Lmbx2 in the graph 1002 correspond to waveforms lmbx1 and Lmbx2 in 1003, respectively. It is, therefore, found that the projection pattern is two-dimensionally luminance-modulated in the x coordinate direction and the y coordinate direction.

A processing procedure according to the second embodiment is the same as that shown in FIG. 9 in the first embodiment and a description thereof will be omitted. The second embodiment has been described.

According to the second embodiment, it is possible to widen the luminance dynamic range of an active type distance measurement apparatus by two-dimensionally modulating a pattern in the x coordinate direction and the y coordinate direction to two-dimensionally distribute a measurable reflectance range.

### Third Embodiment

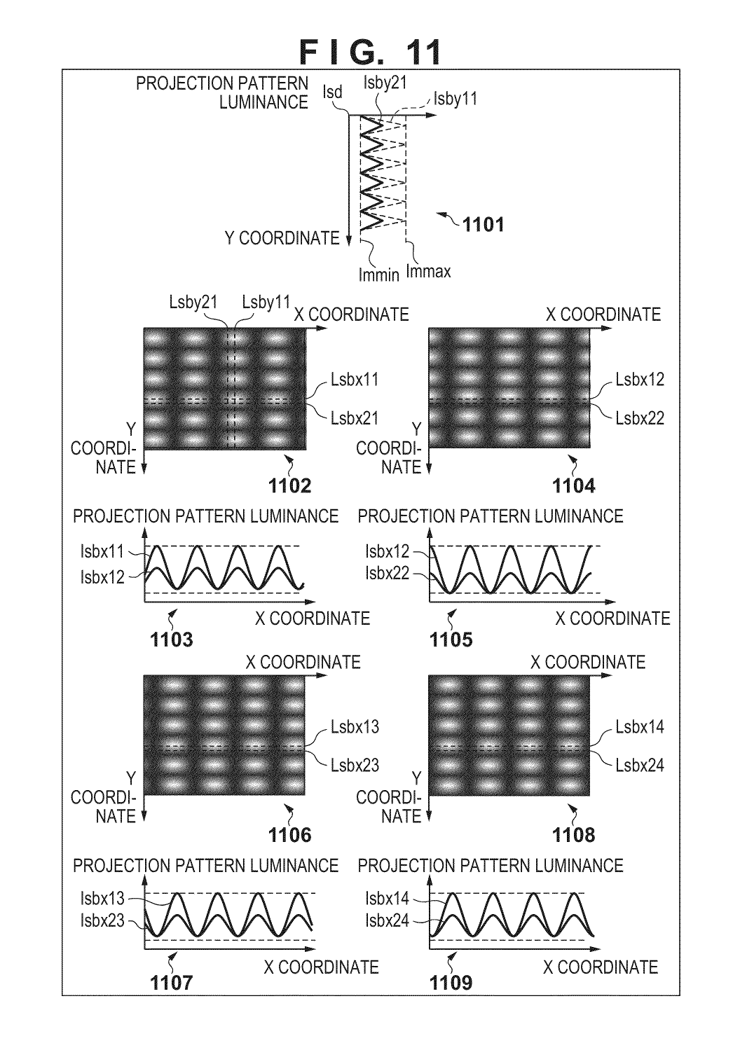

The schematic configuration of a distance measurement apparatus according to the third embodiment of the present invention is the same as that shown in FIG. 1 in the first embodiment. Note that in the third embodiment, a phase calculation unit 40 and a phase connection unit 41 in FIG. 1 operate. The function of each processing unit will be described later. In the first and second embodiments, a space encoding method is used as a distance measurement method. On the other hand, in the third embodiment, a four-step phase shift method is used as a distance measurement method. In a phase shift method, a sinusoidal wave pattern (sinusoidal wave pattern light) is projected. In the four-step phase shift method, four patterns obtained by shifting the phase of a sinusoidal wave by π/2 are projected. FIG. 11 shows projection patterns according to the third embodiment. In a graph 1101, the abscissa represents the projection pattern luminance and the ordinate represents the y coordinate. In projection patterns 1102, 1104, 1106, or 1108, the abscissa represents the x coordinate and the ordinate represents the y axis. In graphs 1103, 1105, 1107, and 1109, the abscissa represents the x coordinate and the ordinate represents the projection pattern luminance.

The projection patterns 1102 and 1103 have a phase shift amount of 0. The projection patterns 1104 and 1105 have a phase shift amount of π/2. The projection patterns 1106 and 1107 have a phase shift amount of π. The projection patterns 1108 and 1109 have a phase shift amount of 3π/2.

Vertical lines Lsby11 and Lsby21 in the graph 1102 correspond to waveforms lsby11 and lsby21 in the graph 1101, respectively. In the third embodiment, a sinusoidal wave pattern according to the phase shift method is one-dimensionally luminance-modulated in the y coordinate direction with a triangular waveform. Horizontal lines Lsbx11, Lsbx12, Lsbx13, and Lsbx14 in the graphs 1102, 1104, 1106, and 1108 correspond to waveforms lsbx11, lsbx12, lsbx13, and lsbx14 in the graphs 1103, 1105, 1107, and 1109, respectively. Horizontal lines Lsbx21, Lsbx22, Lsbx23, and Lsbx24 in the graphs 1102, 1104, 1106, and 1108 correspond to waveforms lsbx21, Lsbx22, Lsbx23, and lsbx24 in the graphs 1103, 1105, 1107, and 1109, respectively. It is found that the waveforms are obtained by sequentially shifting the phase of the sinusoidal wave by π/2 in the x coordinate direction. It is also found that the amplitude of the sinusoidal wave is different depending on the y coordinate position.

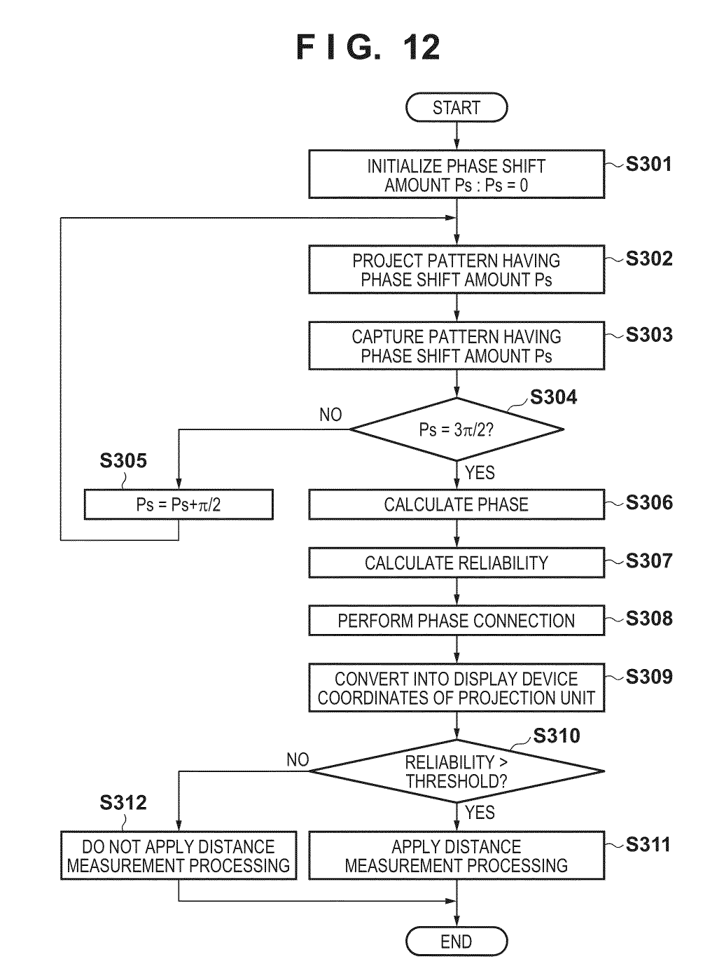

A processing procedure according to the third embodiment will be described with reference to FIG. 12.

In step S301, a projection pattern control unit 31 initializes a phase shift amount Ps to 0.

In step S302, a projection unit 1 projects a pattern having the phase shift amount Ps. In step S303, an image capturing unit 2 captures an image of a measurement object 5 on which the pattern having the phase shift amount Ps has been projected.

In step S304, the projection pattern control unit 31 determines whether the phase shift amount Ps reaches 3π/2. If it is determined that Ps reaches 3π/2 (YES in step S304), the process advances to step S306; otherwise (NO in step S304), the process advances to step S305 to add π/2 to Ps. Then, the process returns to step S302. In step S306, a phase calculation unit 40 calculates a phase. The unit 40 calculates a phase φ for each pixel according to

φ=tan−1((13−11)/(10−12)) (8)

where 10 represents an image luminance value with Ps=0, 11 represents an image luminance value with Ps=π/2, 12 represents an image luminance value with Ps=π, 13 represents an image luminance value with Ps=3π/2.

In step S307, a reliability calculation unit 37 calculates a reliability. In the phase shift method, as the amplitude of a sinusoidal wave received as an image signal is larger, the calculation accuracy of a calculated phase is higher. It is, therefore, possible to calculate a reliability Cf according to equation (9) for calculating the amplitude of a sinusoidal wave.

Cf=(10−12)/2 cos φ (9)

If one of the four captured images is saturated or is at a low level, the waveform is distorted with respect to the sinusoidal wave, thereby decreasing the phase calculation accuracy. In this case, Cf is set to 0.

In step S308, a phase connection unit 41 performs phase connection based on the calculated phase. Various methods for phase connection have been proposed. For example, a method which uses surface continuity, or a method which additionally uses a space encoding method can be used.

In step S309, a conversion processing unit 39 performs conversion into display device coordinates of the projection unit 1 based on the phase undergone phase connection. Upon conversion into display device coordinates of the projection unit 1, it is possible to obtain an emitting direction from the projection unit 1, thereby enabling to perform distance measurement.

In step S310, the reliability calculation unit 37 determines for each pixel of the captured image whether a corresponding reliability is larger than a threshold. If the reliability is larger than the threshold (YES in step S310), the process advances to step S311; otherwise (NO in step S310), the process advances to step S312.

In step S311, a distance calculation unit 33 applies distance measurement processing. Then, the process ends.

In step S312, the distance calculation unit 33 ends the process without applying distance measurement processing. The threshold is determined by converting measurement accuracy ensured by the distance measurement apparatus into a reliability. The processing procedure according to the third embodiment has been described.

According to the third embodiment, it is possible to widen a measurable luminance dynamic range by one-dimensionally luminance-modulating a projection pattern according to the phase shift method.

### Fourth Embodiment

The schematic configuration of a distance measurement apparatus according to the fourth embodiment of the present invention is the same as that shown in FIG. 1 in the first embodiment. In the fourth embodiment, a four-step phase shift method is used as a distance measurement method as in the third embodiment. In the fourth embodiment, a randomly modulated projection pattern is used as a projection pattern for the phase shift method.

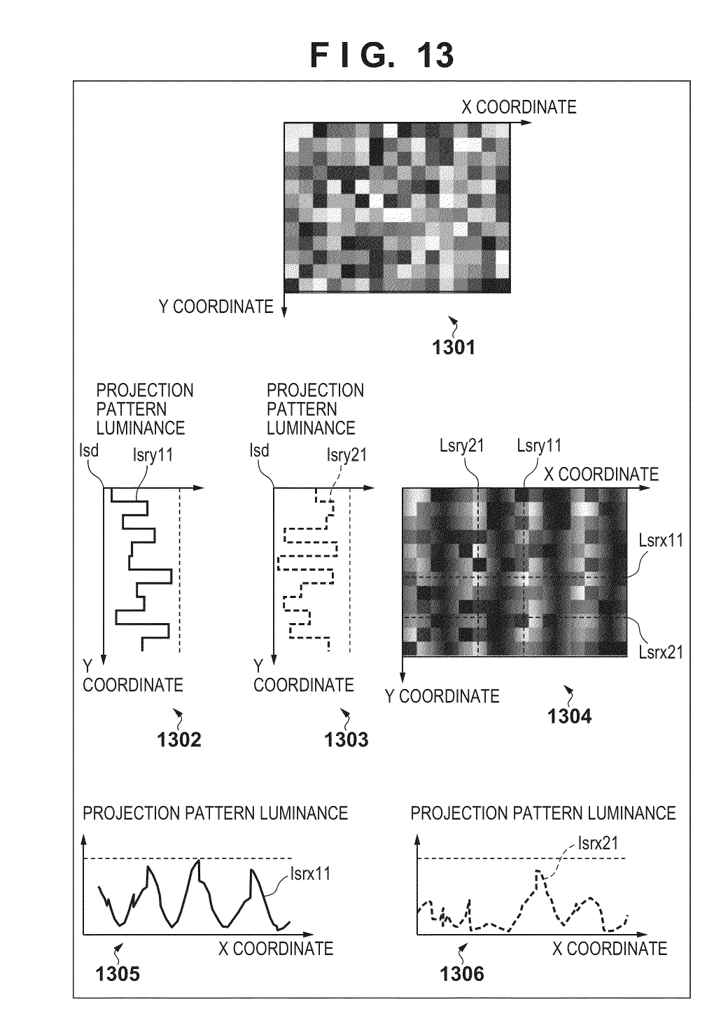

FIG. 13 shows projection patterns according to the fourth embodiment. Reference numeral 1301 denotes a random luminance modulation pattern. In this example, the projection pattern is divided into rectangular regions, and a luminance is randomly set for each rectangular region. If a display device is used for a projection unit 1 as in the schematic configuration shown in FIG. 1, the size of the rectangular region need only be 1 or more pixels. Since the luminance is different for each rectangular region, a rectangular region with a high luminance is suitable for a dark measurement object. To the contrary, a rectangular region with a low luminance is suitable for a bright measurement object. In the fourth embodiment, the luminance is randomly set. It is, therefore, possible to make the distribution of a measurable reflectance of a measurement object spatially consistent.

Graphs 1302 to 1306 respectively show a case in which the phase shift amount of the projection pattern for the phase shift method is 0. In the graphs 1302 and 1303, the abscissa represents the projection pattern luminance and the ordinate represents the y coordinate. In the projection pattern 1304, the abscissa represents the x coordinate and the ordinate represents the y coordinate. In the graphs 1305 and 1306, the abscissa represents the x coordinate and the ordinate represents the projection pattern luminance.

Vertical lines Lsry11 and Lsry21 in the graph 1304 correspond to waveforms lsry11 and lsry21 in the graphs 1302 and 1303, respectively. Horizontal lines Lsrx11 and Lsrx21 in the graph 1304 correspond to waveforms lsrx11 and lsrx21 in the graphs 1305 and 1306, respectively. In the fourth embodiment, the sinusoidal wave pattern for the phase shift method is divided into rectangular regions, a luminance is randomly set for each rectangular region, and luminance modulation is performed. Referring to the graphs 1305 and 1306, it is found that the sinusoidal wave is luminance-modulated in the x coordinate direction with the luminance randomly set for each region.

Although a projection pattern having a phase shift amount of π/2, π, or 3π/2 is not shown in FIG. 13, projection patterns undergone luminance modulation are prepared like FIG. 13. Then, distance measurement is performed according to the same processing procedure as that described with reference to the flowchart of FIG. 12 in the third embodiment. The processing procedure in this embodiment is the same as that illustrated in FIG. 12 and a description thereof will be omitted. The fourth embodiment has been described.

According to the fourth embodiment, using a randomly modulated projection pattern as a projection pattern for the phase shift method, it is possible to widen a measurable luminance dynamic range by two-dimensionally luminance-modulating the projection pattern for the phase shift method.

### Fifth Embodiment

The schematic configuration of a distance measurement apparatus according to the fifth embodiment of the present invention is the same as that shown in FIG. 1 in the first embodiment. Note that in the fifth embodiment, a line extraction unit 42 and element information extraction unit 43 in FIG. 1 operate. The function of each unit will be described later. In the fifth embodiment, a grid pattern projection method is used as a distance measurement method. A projection pattern for the grid pattern projection method is divided into rectangular regions and a projection pattern luminance-modulated for each region is used.

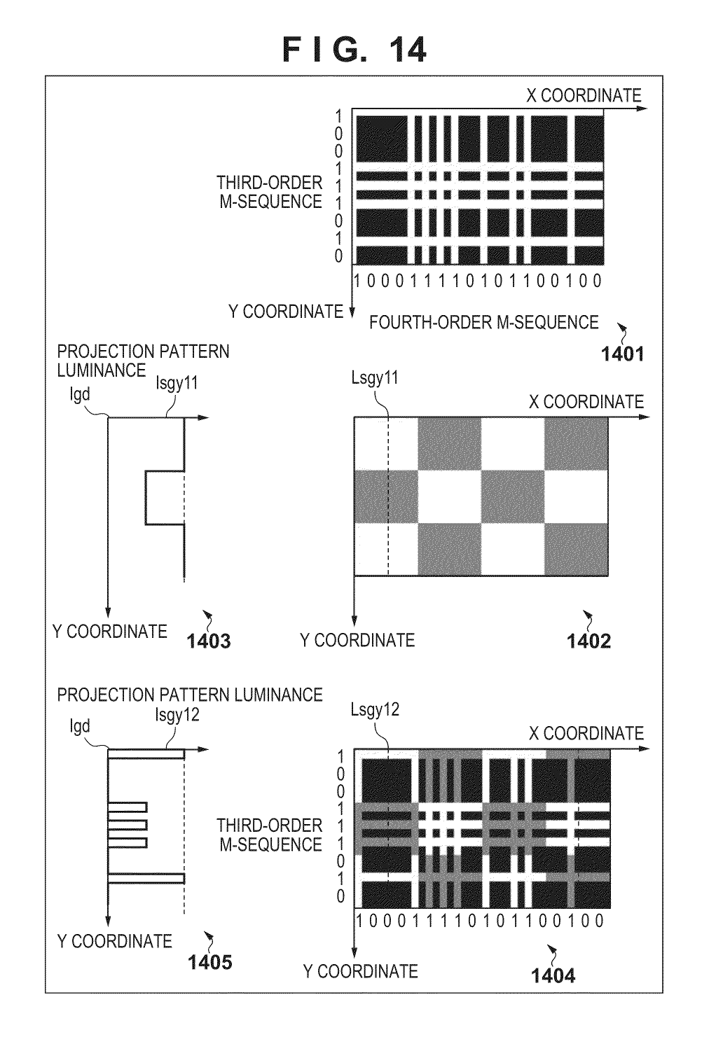

FIG. 14 shows patterns for a grid pattern projection method used in the fifth embodiment. A graph 1401 shows a projection pattern example used in a conventional grid pattern method. In the grid pattern projection method, the presence/absence of a vertical line and a horizontal line is determined based on an m-sequence or de Bruijn sequence to perform encoding. The graph 1401 shows a grid pattern light example based on an m-sequence. A fourth-order m-sequence is indicated in the x coordinate direction and a third-order m-sequence is indicated in the y coordinate direction. For an nth-order m-sequence, if sequence information for n bits is extracted, its sequence pattern appears only once in the sequence. Using the characteristics, extracting sequence information for n bits uniquely identifies coordinates on a display device. In the graph 1401, an element “0” indicates the absence of a line and an element “1” indicates the presence of a line. To clearly discriminate a case in which elements “1” are adjacent to each other, a region having the same luminance as the element “0” is provided between the elements.

A graph 1402 shows a luminance-modulated pattern for the projection pattern shown in the graph 1401. In the graph 1402, the luminance is changed for each rectangular region. The size of a rectangular region needs to be set so that the one rectangular region includes sequence information for n bits in both the x coordinate direction and the y coordinate direction. In the graph 1402, the size of a rectangular region is set so that the region includes sequence information for 4 bits in the x coordinate direction and that for 3 bits in the y coordinate direction. In a graph 1403, the abscissa represents the projection pattern luminance and the ordinate represents the y coordinate. A vertical line Lsgy11 in the graph 1402 corresponds to a waveform lsgy11 in the graph 1403. It is found in the graph 1403 that since the luminance is changed for each rectangular region, luminance modulation with a stepped waveform is performed.

A graph 1404 shows a projection pattern used in the fifth embodiment, which is obtained by luminance-modulating the projection pattern shown in the graph 1401 with the luminance-modulated pattern shown in the graph 1402. In a graph 1405, the abscissa represents the projection pattern luminance and the ordinate represents the y coordinate. It is found that the luminance of the projection pattern is different for each rectangular region. It is possible to arbitrarily set the measurable reflectance of a measurement object within each region by modulating the projection pattern luminance depending on the region. Since the size of a rectangular region is set to include bits corresponding to the order of an m-sequence, distance measurement processing never fails.

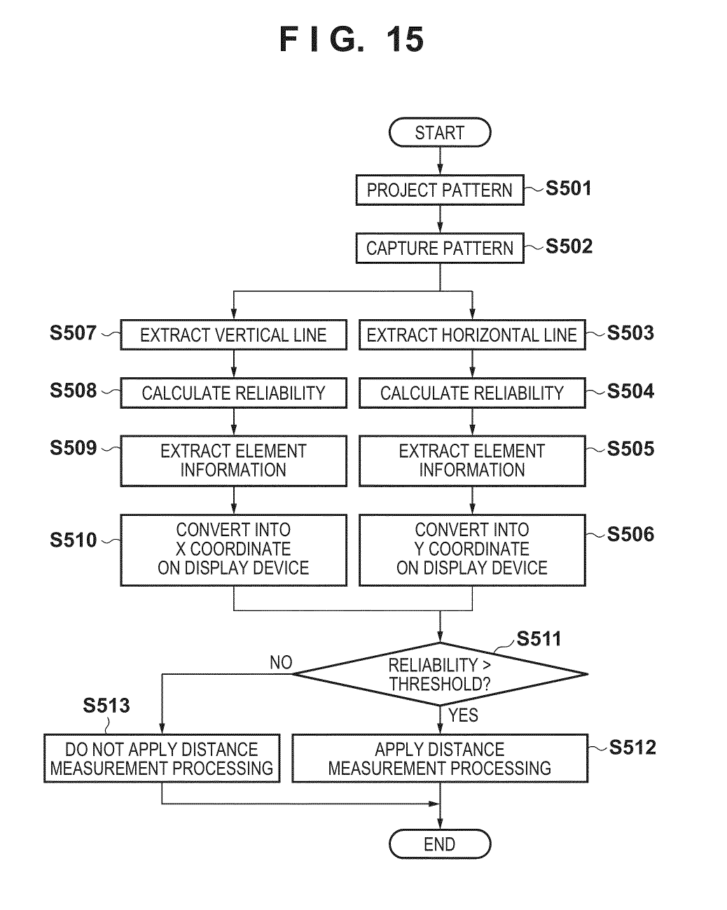

A processing procedure according to the fifth embodiment will be described with reference to a flowchart of FIG. 15. In step S501, a projection unit 1 projects the projection pattern shown in the graph 1404 on a measurement object. In step S502, an image capturing unit 2 captures an image of the measurement object on which the projection pattern has been projected. The process advances to steps S503 and S507.

In step S503, the line extraction unit 42 extracts a horizontal line from the captured image. To extract a horizontal line, various edge detection filters such as a Sobel filter are used. In step S504, a reliability calculation unit 37 calculates a reliability based on the output value of a filter used to extract the line. In general, as the contrast of the pattern of the captured image is higher, the output value of the filter is larger. Therefore, the output value of the filter can be used as a reliability.

In step S505, the element information extraction unit 43 extracts element information. For each portion of the image, a value of 1 or 0 is assigned based on the presence/absence of a line.

In step S506, a conversion processing unit 39 converts the extracted element information into a y coordinate on the display device. If the pieces of element information are extracted and some of the pieces of element information corresponding to the order of an m-sequence are connected, it is possible to uniquely identify the position of each element in the whole sequence. With this processing, it is possible to convert the element information into an y coordinate on the display device. In step S507, the line extraction unit 42 extracts a vertical line from the captured image. To extract a vertical line, various edge detection filters such as a Sobel filter are used.

In step S508, the reliability calculation unit 37 calculates a reliability based on the output value of a filter used to extract the line. In general, as the contrast of the pattern of the captured image is higher, the output value of the filter is larger. Therefore, the output value of the filter can be used as a reliability.

In step S509, the element information extraction unit 43 extracts element information. For each portion of the image, a value of 1 or 0 is assigned based on the presence/absence of a line. In step S510, the conversion processing unit 39 converts the extracted element information into an x coordinate on the display device. If the pieces of element information are extracted and some of the pieces of element information corresponding to the order of an m-sequence are connected, it is possible to uniquely identify the position of each element in the whole sequence. With this processing, it is possible to convert the element information into an x coordinate on the display device.

In step S511, the reliability calculation unit 37 determines whether the calculated reliability of the vertical line or horizontal line is larger than a threshold. If it is determined that the reliability of the vertical line or horizontal line is larger than the threshold (YES in step S511), the process advances to step S512. If it is determined that both the reliabilities of the vertical line and the horizontal line are equal to or smaller than the threshold (NO in step S511), the process advances to step S513.

In step S512, a distance calculation unit 33 performs distance measurement using a triangulation method based on the x or y coordinate on the display device. Then, the process ends. In step S513, the distance calculation unit 33 ends the process without applying the distance measurement processing.

The processing procedure according to the fifth embodiment has been described. In the fifth embodiment, a case in which the present invention is applied to a grid pattern projection method based on an m-sequence has been explained. Note that the present invention is also applicable to a grid pattern projection method based on another sequence including a de Brujin sequence.

According to the fifth embodiment, it is possible to widen a measurable luminance dynamic range by dividing a projection pattern for the grid pattern projection method into rectangular regions and using a luminance-modulated projection pattern for each region.

A case in which the present invention is applied to a space encoding method has been described in the first and second embodiments. A case in which the present invention is applied to a phase shift method has been explained in the third and fourth embodiments. Furthermore, a case in which the present invention is applied to a grid pattern projection method has been described in the fifth embodiment. Note that the present invention is not limited to the three methods described above in respective embodiments, and is applicable to various pattern projection methods including a light-section method.

According to the present invention, it is possible to widen the luminance dynamic range of an active type distance measurement apparatus without prolonging the measurement time or using any special image sensor.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-279875 filed on Dec. 15, 2010, which is hereby incorporated by reference herein in its entirety.

1. A distance measurement apparatus comprising:
modulation means for modulating a luminance value of measurement wave pattern light to be projected on a measurement object for each two-dimensional position of the pattern light within a predetermined luminance value range;
projection means for projecting, on the measurement object, the pattern light modulated by said modulation means;
image capturing means for capturing the measurement object on which the pattern light has been projected by said projection means; and
distance calculation means for calculating a distance to the measurement object based on the captured image captured by said image capturing means.

2. The apparatus according to claim 1, wherein
said modulation means modulates the luminance value of the pattern light, in a direction different from a base line direction which connects said projection means with said image capturing means, within the predetermined luminance value range for each two-dimensional position where the pattern light is projected.

3. The apparatus according to claim 2, wherein
said modulation means modulates the luminance value of the pattern light in the direction different from the base line direction in a predetermined luminance value cycle.

4. The apparatus according to claim 3, wherein
the predetermined luminance value cycle is one of luminance value cycles of a triangular wave, stepped wave, and sawtooth wave.

5. The apparatus according to claim 2, wherein
said modulation means randomly modulates the luminance value of the pattern light.

6. The apparatus according to claim 2, wherein
the direction different from the base line direction is a direction perpendicular to the base line direction.

7. The apparatus according to claim 2, wherein
the base line direction is an epipolar line direction which is determined based on a spatial positional relationship among said projection means, said image capturing means, and the measurement object.

8. The apparatus according to claim 1, wherein
the measurement pattern light is gray code pattern light, and
said distance calculation means calculates the distance based on the captured image using a space encoding method.

9. The apparatus according to claim 1, wherein
the measurement pattern light is sinusoidal wave pattern light, and
said distance calculation means calculates the distance based on the captured image using a phase shift method.

10. The apparatus according to claim 1, wherein
the measurement pattern light has a grid pattern, and
said distance calculation means calculates the distance based on the captured image using a grid pattern projection method.

11. A distance measurement method comprising:
a modulation step of modulating, within a predetermined luminance value range, a luminance value of measurement wave pattern light to be projected on a measurement object for each two-dimensional position where the pattern light is projected;
a projection step of projecting, on the measurement object, the pattern light modulated in the modulation step;
an image capturing step of capturing the measurement object on which the pattern light has been projected in the projection step; and
a distance calculation step of calculating distance to the measurement object based on the captured image captured in the image capturing step.

12. A non-transitory computer-readable storage medium storing a computer program for causing a computer to execute each step of a distance measurement method according to claim 11.
